(19) United States
(12) Patent Application Publication
(10) Pub. No.: US 2003/0087118 A1
(43) Pub. Date: May 8, 2003

(54) Diffusion bonded metal laminate

(76) Inventors: William R. Kingston, Chino Hills, CA (US); Ronaldo A. Storf, Newport Beach, CA (US)

Correspondence Address: David A. Farah, M.D., SHELDON & MAK, 9th Floor, 225 South Lake Avenue, Pasadena, CA, 91101, US

(21) Appl. No.: 10/140,222

(22) Filed: May 6, 2002

Related U.S. Application Data
(60) Provisional application No. 60/345,920, filed on Nov. 8, 2001.

(51) Int. Cl. B32B 15/01

(52) U.S. Cl. 428/615; 428/926

(57) ABSTRACT

A multilayered material 10 having a first material 12 with a first surface 14 and an opposing second surface 16, and a first material thickness 18 between the first surface 14 and the second surface 16, and a second material 24 plated and diffusion bonded onto at least one surface of the first material 12, where the first material 12 with the diffusion bonded second material 24 is cold rolled to a lesser total thickness.

### CROSS-REFERENCE TO RELATED APPLICATIONS

The present Application claims the benefit of U.S. Provisional Patent Application No. 60/345,920, titled “Diffusion Bonded Metal Laminate” and filed Nov. 8, 2001, the contents of which are incorporated in this disclosure by reference in their entirety.

### BACKGROUND

Many industrial applications require materials that possess a combination of high strength, low weight and damage resistance. These applications include uses of materials exposed to environmental extremes. Unfortunately, it is frequently impossible to identify a single substance that optimally possesses all of these properties.

One application for materials possessing high strength, low weight and damage resistance are for the construction of parts for motor and human powered vehicles, such as batteries and catalytic converters, in order to provide satisfactory structural integrity and damage resistance, while increasing the range of the vehicle for a given amount of fuel or power. Such vehicles include automobiles, trucks, airplanes, trains, bicycles, motorcycles, and spacecraft. Other applications include golf clubs, tubular structures such as softball bats, skis, and surf and snow boards.

Hence, there is a need for high strength, lightweight materials for use in industrial applications, such as for parts of motor and human powered vehicles, among other uses. Further, there remains a need for a method of making such materials.

### SUMMARY

In one embodiment, there is provided a multilayered material. The multilayered material comprises a first material comprising a first surface and an opposing second surface and a second material plated and diffusion bonded onto at least one surface of the first material. The first material with the diffusion bonded second material is cold rolled to produce the multilayered material.

In a preferred embodiment, the multilayered material has a thickness of between about 1μ and about 5000μ. In a preferred embodiment, the multilayered material has a thickness of between about 5μ and about 100μ. In a particularly preferred embodiment, the multilayered material has a thickness of about 25μ.

In one embodiment, the first material has a yield strength greater than 140 MPa. In another embodiment, the first material comprises a first metal. In a preferred embodiment, the first material is selected from the group consisting of copper, iron, nickel, molybdenum, steel, titanium and alloys containing a majority of one or more than one of the preceding. In a particularly preferred embodiment, the first metal is a nickel alloy. In another particularly preferred embodiment, the first metal is stainless steel, such as UNS S 32100.

In one embodiment, the first material comprises a plurality of layers, and at least two of the plurality of layers comprise different materials. In another embodiment, the first material comprises a plurality of layers, and at least two of the plurality of layers comprise substantially equal thicknesses. In another embodiment, the first material comprises a plurality of layers, and at least two of the plurality of layers comprise different materials. In another embodiment, the first material comprises a plurality of layers, and at least one of the plurality of layers comprises a different material than the second material.

In one embodiment, the second material has a thickness of between about 0.1μ and about 20μ. In another embodiment, the second material has a thickness of between about 0.5μ and about 5μ. In another embodiment, the second material has a thickness of about 1μ.

In a preferred embodiment, the second material is selected from the group consisting of chrome, molybdenum, nickel, niobium, palladium and platinum. In another preferred embodiment, the second material comprises a plurality of layers, and at least two of the plurality of layers comprise different materials. In a particularly preferred embodiment, the second material comprises a plurality of layers, and at least one of the plurality of layers comprises nickel and at least one of the plurality of layers comprises platinum. In another particularly preferred embodiment, the second material is plated and diffusion bonded onto both the first surface and the second surface of the first material.

In one embodiment, there is provided a method of making a multilayered material. The method comprises, first, providing a first material comprising a first surface and an opposing second surface and then, providing a second material. The second material is plated and diffusion bonded onto at least one surface of the first material and, then, the first material with the diffusion bonded second material is cold rolled. In a preferred embodiment, plating and diffusion bonding the second material onto at least one surface of the first material comprises plating and diffusion bonding the second material onto both surfaces of the first material. In another preferred embodiment, plating and diffusion bonding the second material comprises placing the first material into a bath of the second material, followed by heating the first material. In another preferred embodiment, the method further comprises coiling the multilayered material.

In one embodiment, there is provided an article of manufacture, such as a battery or a catalytic converter core, comprising a multilayered material according to the present invention. In another embodiment, there is provided a method of making a finished article of manufacture comprising incorporating a multilayered material according to the present invention into an article of manufacture.

### FIGURES

These and other features, aspects and advantages of the present invention will become better understood with regard to the following description, appended claims, and accompanying figures where:

FIG. 1 is a top perspective view of a sheet of multilayered material according to the present invention comprising one layer of a first material and a second material bonded to each surface of the first material;

FIG. 2 is a side perspective, cutaway view of the sheet of the multilayered material shown in FIG. 1;

FIG. 3 is a side perspective, cutaway view of a sheet of multilayered material according to the present invention comprising a first material with two layers and a second material bonded to each surface of the first material;

FIG. 4 is a side perspective, cutaway view of a sheet of multilayered material according to the present invention comprising a first material and a second material with two layers bonded to each surface of the first material; and

FIG. 5 is a side perspective, cutaway view of a sheet of the multilayered material according to the present invention comprising two layers of a first material interspersed between three layers of a second material.

### DESCRIPTION

According to one embodiment of the present invention, there is provided a multilayered material that comprises a first material with a first surface and a second surface, and that further comprises a second material, different from the first material, that is bonded onto the first surface of the first material. In a preferred embodiment, the second material is bonded onto both the first surface and onto the second surface of the first material. According to another embodiment of the present invention, there is provided a method of making a multilayered material according to the present invention. According to another embodiment of the present invention, there is provided an article of manufacture comprising a multilayered material according to the present invention. According to another embodiment of the present invention, there is provided a method of making an article of manufacture according to the present invention, where the article of manufacture comprises a multilayered material according to the present invention.

As used in this disclosure, the term “commercially pure” means greater than about 98% pure.

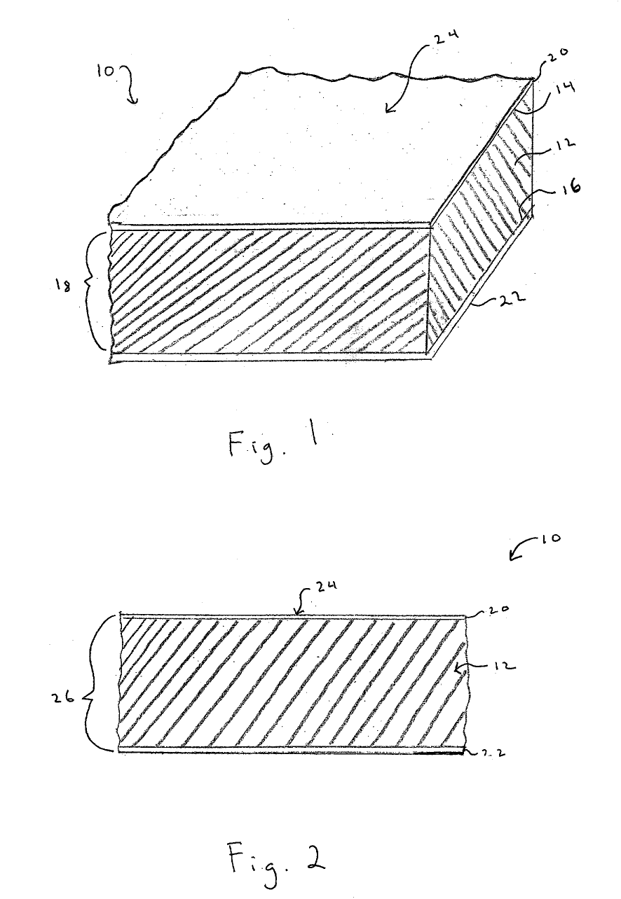

In one embodiment of the present invention, there is provided a multilayered material comprising a first material. Referring now to FIG. 1 and FIG. 2, there are shown a top perspective view of a sheet of multilayered material according to the present invention comprising one layer of a first material and a second material bonded to each surface of the first material, and a side perspective, cutaway view of the sheet of the multilayered material shown in FIG. 1, respectively. As can be seen, the multilayered material 10 comprises a first material 12 having a first surface 14, an opposing second surface 16, a thickness 18 between the first surface 14 and the second surface 16. The multilayered material 10 further comprises two layers 20 and 22 of a second material 24.

Preferably, the first material 12 is capable of being cold rolled into thin sheets, or into coils, or into both thin sheets and coils, having a thickness 18 of between about 1μ and about 5000μ. In another preferred embodiment, the first material 12 is capable of being cold rolled into thin sheets, or into coils, or into both thin sheets and coils, having a thickness 18 of between about 5μ and about 100μ. In a particularly preferred embodiment, the first material 12 is capable of being cold rolled into thin sheets, or into coils, or into both thin sheets and coils, having a thickness 20μ of about 25μ. Since the substantial majority of the total thickness 26 of the multilayered material 10 is from the thickness 18 of the first material 12, the total thickness 26 of multilayered material 10 is approximately the same as the thickness 18 of the first material itself 12.

The first material 12 and the second material 24 are selected according to the properties needed in the multilayered material 10 according to the present invention. In a preferred embodiment, the first material 12 is selected for bulk properties, such as strength and cost. For example, the first material 12 can be selected based on a particular yield strength that is desired in the multilayered material. In one embodiment, the first material 12 has a yield strength greater than about 140 MPa. In another embodiment, the first material 12 is highly formable. In a preferred embodiment, the first material 12 is less expensive than the second material 24 disclosed below, such that there is a cost saving from using the first material 12 in the multilayered material 10 rather than using a material made of commercially pure second material 24.

In a preferred embodiment, the first material 12 comprises a first metal. In another preferred embodiment, the first material 12 is selected from the group consisting of copper, iron, nickel, molybdenum, steel, such as carbon steel or stainless steel, titanium and alloys containing a majority of one or more than one of the preceding. In a particularly preferred embodiment, the first metal is a stainless steel alloy comprising greater than about 10% chrome. In another particularly preferred embodiment, the first metal is stainless steel, such as UNS S 32100.

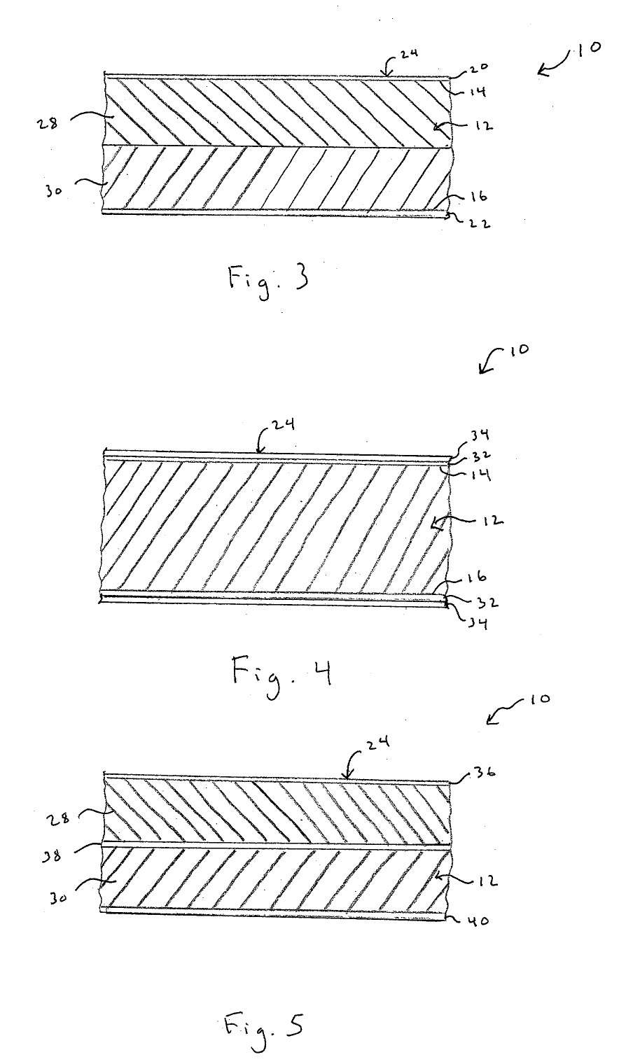

Additionally, the first material 12 can comprise a plurality of layers capable of being bonded together, such as a layer of copper and a layer of nickel, or a layer of copper between two layers of nickel. Referring now to FIG. 3, there is shown a side perspective, cutaway view of a sheet of multilayered material according to the present invention comprising a first material with two layers, 28 and 30, and a layer 20 and 22 of second material 24 bonded to each surface 14 and 16 of the first material 12. The layers 28 and 30 of the plurality of layers can be of substantially equal thickness, as shown, or can be of unequal thicknesses. As will be understood by those with skill in the art with reference to this disclosure, the first material 12 can also comprise materials other than metals having suitable properties as disclosed in this disclosure.

The multilayered material 10 of the present invention further comprises a second material 24. The second material 24 is a different material than the first material 12, if the first material 12 comprises only one layer. If the first material 12 comprises a plurality of layers, the second material 24 is different from at least one layer of the first material 12.

The second material 24 is capable of being diffusion bonded to the first surface of the first material 12. In a preferred embodiment, the second material 24 is plated and diffusion bonded onto the first surface 14 of the first material 12 to form the multilayered material of the present invention. In a particularly preferred embodiment, the multilayered material 10 of the present invention is cold rolled to decrease the thickness after the second material 24 is plated and diffusion bonded onto the first surface 14 of the first material 12.

In a preferred embodiment, the second material 24 has a thickness of between about 0.1μ and about 20μ when diffusion bonded to the first material 12. In another preferred embodiment, the second material 24 has a thickness of between about 0.5μ and about 5μ when diffusion bonded to the first material 12. In a particularly preferred embodiment, the second material 24 has a thickness of about 1μ when diffusion bonded to the first material 12.

The second material 24 is preferably selected so that it imparts the bonded surface of the multilayered material 10 with resistance to one or more than one environmental stress selected from the group consisting of corrosion, oxidation and temperature, or that imparts reduced electrical resistance to the multilayered material. Additionally, the second material 24 is preferably bondable to a surface of the first material 12 in a manner that is both commercially cost effective and in a manner suitable for large scale manufacturing. In another preferred embodiment, the second material 24 is more expensive than the first material 12 disclosed above, such that there is a cost saving from using the first material 12 in the multilayered material rather than using a material made of commercially pure second material 24.

In a preferred embodiment, the second material 24 comprises a second metal. In another preferred embodiment, the second material 24 is selected from the group consisting of chrome, molybdenum, nickel, niobium, palladium and platinum. Additionally, the second material 24 can comprise a plurality of layers capable of being bonded together, such as a layer of nickel and a layer of platinum, or a layer of platinum between two layers of nickel.

Referring now to FIG. 4, there is shown a side perspective, cutaway view of a sheet of multilayered material 10 according to the present invention comprising a first material 12 and a second material 24 with two layers 32 and 34 bonded to each surface 14 and 16 of the first material 12. The layers 32 and 34 of the second material can be of substantially equal thickness, as shown, or can be of unequal thicknesses.

In one embodiment, the multilayered material 10 of the present invention comprises one layer of the first material and one layer of the second material 24 bonded to the first surface of the first material. In a preferred embodiment, as shown in FIG. 1 and FIG. 2, the multilayered material 10 of the present invention material comprises one layer of the first material 12 and two layers 20 and 22 of the second material 24, where the first layer 20 of the second material 24 is bonded to the first surface 14 of the first material 12, and where the second layer 22 of the second material 24 is bonded to the second surface 16 of the first material 12. As shown in FIG. 4, when two layers 32 and 34 of the second material 24 are present on one surface 14 of the first material 12, the first layer 32 of the second material 24 can be of the same composition, such as nickel, from the second layer 34 of the second material 24, such as nickel, or the first layer 32 of the second material 24 can be of a different composition, such as nickel, from the second layer 34 of the second material 24, such as platinum, as will be understood by those in the art with reference to this disclosure.

In another embodiment, the multilayered material of the present invention material comprises a plurality of layers of the first material alternating with a plurality of layers of the second material 24. Referring now to FIG. 5, there is shown a side perspective, cutaway view of a sheet of the multilayered material according to the present invention comprising two layers of a first material interspersed between three layers of a second material. As can be seen, the multilayered material 10 can comprise two layers 28 and 30 of the first material 12, and three layers 36, 38 and 40 of the second material 24, with a layer of the first material 12 between each two layers of the second material 24.

In another embodiment, the present invention is a method of making the multilayered material of the present invention. The method comprises, first, providing a first material and providing a second material selected as disclosed in this disclosure. Next, the second material is plated and diffusion bonded to one surface, and preferably both surfaces, of the first metal.

In one embodiment, the second material is plated and diffusion bonded to the first material by placing the first material into an electroless bath of the second material, followed by heating the first material to diffusion bond the second material to each surface of the first material. Then, the first material with the second material bonded to its surfaces is cold rolled to a sheet or strip of multilayered material. The multilayered material is optionally rolled into a coil for storage. The method can also comprise heating the multilayered material to alter the properties of the multilayered material, such as annealing the multilayered material, or hardening the multilayered material by heating and cooling the multilayered material at appropriate temperatures.

In another embodiment, the present invention is an article of manufacture comprising a multilayered material according to the present invention. Examples of such articles include anode substrates in ni-cad batteries and honeycomb catalytic converter cores.

In another embodiment, the present invention is a method of making an article of manufacture according to the present invention, where the article of manufacture comprises a multilayered material according to the present invention. The method comprises, first, providing a multilayered material according to the present invention. Next, the multilayered material is cut as necessary, and is shaped or formed into the article of manufacture, or into a part for an article of manufacture and the part is incorporated into the article of manufacture.

### EXAMPLE I

### Method of Making a Multilayered Material Comprising Low Carbon Steel and Nickel

A multilayered material according to the present invention was made as follows. First, a first metal comprising a coil of low carbon steel having a thickness of about 100μ was obtained from Corona Alloys, Corona, Calif. US. Next, the coil of low carbon steel was cleaned and rinsed on a continuous cleaning and plating line. Then, a second material, was provided by dissolving solid commercially pure nickel in a plating solution. Next, the cleaned coil of low carbon steel was plated on both surfaces with the nickel, in an electroless plating bath (such as available from Precious Plate Florida, Palm Beach, Fla. US or Metal Surfaces Inc., Bell, Calif. US) and the low carbon steel with the nickel plating was rewound into a coil, producing a coil of low carbon steel that was nickel plated on both surfaces.

The nickel plated, low carbon steel coil was then fully diffusion bonded by heating the coil in a muffle furnace with argon atmosphere on a continuous line at a rate of about 100 to 125 cm per minute at 850° C. causing the nickel layers to diffusion bond to the low carbon steel layer and to create a diffusion layer at the junction of the nickel and steel layers that comprised a very thin nickel-steel alloy layer. The resultant multilayered material was rewound into a coil.

Finally, the multilayered material was cold rolled from its initial thickness of about 100μ to a final thickness of about 25μ in a multi-roll cluster rolling mill. The cold rolling step proportionately reduced the layers of nickel and the layer of low carbon steel while maintaining the integrity of the diffusion bonded interface.

### EXAMPLE II

### Method of Making a Multilayered Material Comprising Stainless Steel and Platinum

Another multilayered material according to the present invention was made as follows. First, a first metal comprising a coil of UNS S 32100 stainless steel having a thickness of about 100μ was obtained from Brown Metals Co., Rancho Cucamonga, Calif. US. Next, the coil of stainless steel was cleaned and rinsed on a continuous cleaning and plating line. Then, a second material, commercially pure platinum was provided in solution ready for use in plating. Next, the cleaned coil of stainless steel was plated on both surfaces with the platinum, in an electroless plating bath (such as available from Precious Plate Florida, Palm Beach, Fla. US or Metal Surfaces Inc., Bell, Calif. US) and the stainless steel with the platinum plating was rewound into a coil, producing a coil of stainless steel that was platinum plated on both surfaces.

The platinum plated, stainless steel coil was then fully diffusion bonded by heating the coil in a muffle furnace with argon atmosphere on a continuous line at a rate of about 1.2 meters per minute at 1150° C. causing the platinum layers to diffusion bond to the stainless steel layer and to create a diffusion layer at the junction of the platinum and steel layers that comprised a very thin platinum-steel alloy layer. The resultant multilayered material was rewound into a coil.

Finally, the multilayered material was cold rolled from its initial thickness of about 100μ to a final thickness of about 25μ in a multi-roll cluster rolling mill. The cold rolling step proportionately reduced the layers of platinum and the layer of stainless steel while maintaining the integrity of the diffusion bonded interface.

### EXAMPLE III

### Method of Making a Multilayered Material Comprising Titanium and Platinum

Another multilayered material according to the present invention was made as follows.

First, a first metal comprising a coil of AMS 4914 titanium having a thickness of about 250μ was obtained from Corona Alloys, Corona, Calif. US. Next, the coil of titanium was cleaned and rinsed on a continuous cleaning and plating line. Then, a second material, commercially pure platinum was provided in solution ready for use in plating. Next, the cleaned coil of titanium was plated on both surfaces with the platinum, in an electroless plating bath (such as available from Precious Plate Florida, Palm Beach, Fla. US or Metal Surfaces Inc., Bell, Calif. US) and the titanium with the platinum plating was rewound into a coil, producing a coil of titanium that was platinum plated on both surfaces.

The platinum plated, titanium coil was then fully diffusion bonded by heating the coil in vacuum at 480° C. to 650° C. for about 8 hours causing the platinum layers to diffusion bond to the titanium layer and to create a diffusion layer at the junction of the platinum and titanium layers that comprised a very thin platinum-titanium alloy layer. The resultant multilayered material was rewound into a coil.

Finally, the multilayered material was cold rolled from its initial thickness of about 250μ to a final thickness of about 125μ in a multi roll cluster rolling mill. The cold rolling step proportionately reduced the layers of platinum and the layer of titanium while maintaining the integrity of the diffusion bonded interface.

Although the present invention has been discussed in considerable detail with reference to certain preferred embodiments, other embodiments are possible. Therefore, the scope of the appended claims should not be limited to the description of preferred embodiments contained in this disclosure.

What is claimed is:

1. A multilayered material comprising:
a) a first material comprising a first surface and an opposing second surface, and a first material thickness between the first surface and the second surface; and
b) a second material plated and diffusion bonded onto at least one surface of the first material; and
where the first material with the diffusion bonded second material is cold rolled to produce the multilayered material.

2. The multilayered material of claim 1, where the multilayered material has a thickness; and
where the thickness is between about 1μ and about 5000μ.

3. The multilayered material of claim 1, where the multilayered material has a thickness; and
where the thickness is between about 5μ and about 100μ.

4. The multilayered material of claim 1, where the multilayered material has a thickness; and
where the thickness is about 25μ.

5. The multilayered material of claim 1, where the first material has a yield strength greater than 140 MPa.

6. The multilayered material of claim 1, where the first material comprises a first metal.

7. The multilayered material of claim 1, where the first material is selected from the group consisting of copper, iron, nickel, molybdenum, steel, titanium and alloys containing a majority of one or more than one of the preceding.

8. The multilayered material of claim 1, where the first metal is a steel alloy.

9. The multilayered material of claim 1, where the first material comprises a plurality of layers; and
where at least two of the plurality of layers comprise different materials.

10. The multilayered material of claim 1, where the first material comprises a plurality of layers; and
where at least two of the plurality of layers comprise substantially equal thicknesses.

11. The multilayered material of claim 1, where the first material comprises a plurality of layers; and
where at least two of the plurality of layers comprise different materials.

12. The multilayered material of claim 1, where the first material comprises a plurality of layers; and
where at least one of the plurality of layers comprise a different material than the second material.

13. The multilayered material of claim 1, where the second material has a thickness of between about 0.1μ and about 20μ.

14. The multilayered material of claim 1, where the second material has a thickness of between about 0.5μ and about 5μ.

15. The multilayered material of claim 1, where the second material has a thickness of about 1μ.

16. The multilayered material of claim 1, where the second material is selected from the group consisting of chrome, molybdenum, nickel, niobium, palladium and platinum.

17. The multilayered material of claim 1, where the second material comprises a plurality of layers; and
where at least two of the plurality of layers comprise different materials.

18. The multilayered material of claim 1, where the second material comprises a plurality of layers; and
where at least one of the plurality of layers comprises nickel and at least one of the plurality of layers comprises platinum.

19. The multilayered material of claim 1, where the second material is plated and diffusion bonded onto both the first surface and the second surface of the first material.

20. A method of making a multilayered material comprising:
a) providing a first material comprising a first surface and an opposing second surface;
b) providing a second material;
c) plating and diffusion bonding the second material onto at least one surface of the first material; and
d) cold rolling the first material with the diffusion bonded second material.

21. The method of claim 19, where plating and diffusion bonding the second material onto at least one surface of the first material comprises plating and diffusion bonding the second material onto both surfaces of the first material.

22. The method of claim 19, where plating and diffusion bonding the second material comprises placing the first material into a bath of the second material, followed by heating the first material.

23. The method of claim 19, further comprising coiling the multilayered material.

24. An article of manufacture comprising a multilayered material according to claim 1.

25. A battery comprising the multilayered material according to claim 1.

26. A catalytic converter core comprising the multilayered material according to claim 1.

27. A method of making a finished article of manufacture comprising incorporating a multilayered material according to claim 1 into an article of manufacture.
